(19) United States
(12) Patent Application Publication
(10) Pub. No.: US 2026/0160083 A1
(43) Pub. Date: Jun. 11, 2026

(54) ANTI-CRACK ASSEMBLY FOR CORNER WALL OF DOOR AND WINDOW

(71) Applicants: CHIH-CHENG LIN, TAINAN CITY (TW); CHUAN-HSUAN LIN, TAINAN CITY (TW)

(72) Inventors: CHIH-CHENG LIN, TAINAN CITY (TW); CHUAN-HSUAN LIN, TAINAN CITY (TW)

(21) Appl. No.: 18/973,986

(22) Filed: Dec. 9, 2024

(51) Int. Cl. E04G 15/02

(52) U.S. Cl. CPC E04G 15/02

(57) ABSTRACT

An anti-crack assembly for corner walls of doors and windows is provided. A plurality of anti-crack components is spaced apart from one another and connected by fixing rods inserted through the anti-crack components. Two reinforcement pieces of a reinforcement unit are arranged at two ends of the fixing rod correspondingly and an anti-shock piece between the two reinforcement pieces is going across notches of the anti-crack components. A locking slot is mounted to each of two sides which form the notch of the anti-crack component. An edge of each of two sides of the anti-shock piece is provided with a locking hook portion able to be engaged and connected with the locking slot. Thereby the anti-shock piece and the anti-crack components are assembled conveniently. Moreover, the reinforcement unit increases bond area, resistance to stress and anti-crack performance of the walls to protect the walls from micro-cracks.

### FIELD OF THE INVENTION

The present invention relates to an anti-crack assembly used as a building component, especially to an anti-crack assembly for corner walls of doors and windows.

### DESCRIPTION OF RELATED ART

Generally, walls of buildings are installed with windows. When the building has thermal expansion or vibration due to earthquake, cracks occur around corners of window frames in the wall. Rain water can infiltrate the building through the cracks. In order to improve anti-crack strength of wall structure around the corners of the window or door frames and protect the wall structure around the corners from cracks or micro-cracks due to earthquake or other external forces, inventors of the present invention have invented and developed products related to anti-crack assembly for corner walls of doors and windows in sequence as those revealed in Taiwanese Pat. Pub. No. I650468 “AN ANTI-CRACKING COMPONENT OF STRUCTURAL WALL FOR WINDOW CORNER”, Taiwanese Pat. Pub. No. M582057 “Fixing structure for anti-cracking component of window angle wall surface”, Taiwanese Pat. Pub. No. I695106 “ANTI-CRACKING COMPONENT STRUCTURE FOR DOOR AND WINDOW CORNER WALLS”, Taiwanese Pat. Pub. No. M594053 “Door and window corner wall crack-resisting component structure”, Taiwanese Pat. Pub. No. M592012 “Door and window corner wall surface anti-cracking component structure” in sequence.

After installation of the above door and window corner wall surface anti-cracking components, openings reserved for the door or the window are formed in the wall structure. After door and window frames being mounted into the openings, a gap generated is filled with cement mortar to form a seam. When earthquake stress is transmitted to the seam, the seam and its paint layer are easy to have micro-cracks. Thus the inventors of the present invention have developed “Door and window corner wall crack-resisting component structure” revealed in Taiwanese Pat. Pub. No. I708882. As shown in FIG. 15, a crack-resisting assembly for door and window corner walls mainly includes a plurality of crack-resisting components m1 spaced apart and inserted by a fixing rod m2 for connection with one another. Two reinforcement pieces m31 of a reinforcement unit m3 are connected with two ends of the fixing rod m2 and a vibration absorption member m32 is arranged between the two reinforcement pieces m31. Each of the two reinforcement pieces m31 is provided with a seam reinforcement part m33. When the crack-resisting assembly for door and window corner walls is in use, the seam reinforcement parts m33 are connected with the seams at corners of the door frame and the window frame. Thus crack-resisting strength of the wall structure and the seams at the corners of the door and the window frames is increased by the arrangement of the seam reinforcement parts m33 of the reinforcement unit m3. Therefore, the seam at the corners of the door and the window frames and its paint layer are protected from having micro-cracks during the earthquake.

According to the above development history, the inventors of the present invention are dedicated to improving the related products continuously in order to make the products easier to use and more practical. Although the crack-resisting strength of the wall structure and the seams at the corners of the door and the window frames is increased by the arrangement of the reinforcement unit m3 in the Taiwanese Pat. Pub. No. I708882 “Door and window corner wall crack-resisting component structure”, the design still has certain shortcoming. During assembly, the vibration absorption member m32 needs to be fixed on notches of the plurality of the crack-resisting components m1 in turn by spot welding. Thereby assembly and use of the reinforcement unit m3 are still inconvenient. Thus there is room for improvement and there is a need to provide a novel crack-resisting assembly for door and window corner walls.

### SUMMARY OF THE INVENTION

Therefore, it is a primary object of the present invention to provide an anti-crack assembly for corner walls of doors and windows having a plurality of anti-crack components which is easy to assemble and able to protect wall structures at corners of door and window frames from cracks effectively.

In order to achieve the above object, an anti-crack assembly for corner walls of doors and windows according to the present invention includes a plurality of anti-crack components spaced apart from one another and connected by a plurality of fixing rods inserted through the anti-crack components. Two reinforcement pieces of a reinforcement unit are arranged at two ends of the fixing rod correspondingly and an anti-shock piece between the two reinforcement pieces is going across notches of the anti-crack components. A locking slot is mounted to each of two sides of the anti-crack component which form the notch of the anti-crack components. An edge of each of two sides of the anti-shock piece is provided with a locking hook portion able to be engaged and connected with the locking slot. Thereby the anti-shock piece and the anti-crack components are assembled conveniently. Moreover, bond area, resistance to stress and anti-crack strength of wall structures at corners of door and window frames are improved by the reinforcement unit. Therefore, the wall structures at the corners of the door and window frames and their paint layers are protected from micro-cracks.

### BRIEF DESCRIPTION OF THE DRAWINGS

FIG. 1 is an exploded view of an embodiment according to the present invention;

FIG. 2 is a perspective view of an embodiment according to the present invention;

FIG. 3 is a front view of an embodiment according to the present invention;

FIG. 4 is a front view of an anti-crack component of an embodiment according to the present invention;

FIG. 5 is a partial enlarged sectional view of an anti-crack component assembled with an anti-shock piece according to the present invention;

FIG. 6 is a front view showing an embodiment installed on a door frame template and a window frame template while in use according to the present invention;

FIG. 7 is a perspective view showing an embodiment mounted with reinforcing bars in use according to the present invention;

FIG. 8 is a top view showing an embodiment mounted with reinforcing bars and templates in use according to the present invention;

FIG. 9 is a sectional view showing an embodiment assembled with a normal door frame and a normal window frame according to the present invention;

FIG. 10, a partial enlarged sectional view showing an embodiment assembled with a normal door frame and a normal window frame according to the present invention;

FIG. 11 is a perspective view of another embodiment according to the present invention;

FIG. 12 is an exploded view of a further embodiment according to the present invention;

FIG. 13 is an exploded view of a further embodiment according to the present invention;

FIG. 14 is a perspective view of a further embodiment according to the present invention;

FIG. 15 is a perspective view showing structure of an embodiment of an anti-crack assembly for corner walls of doors and windows available now.

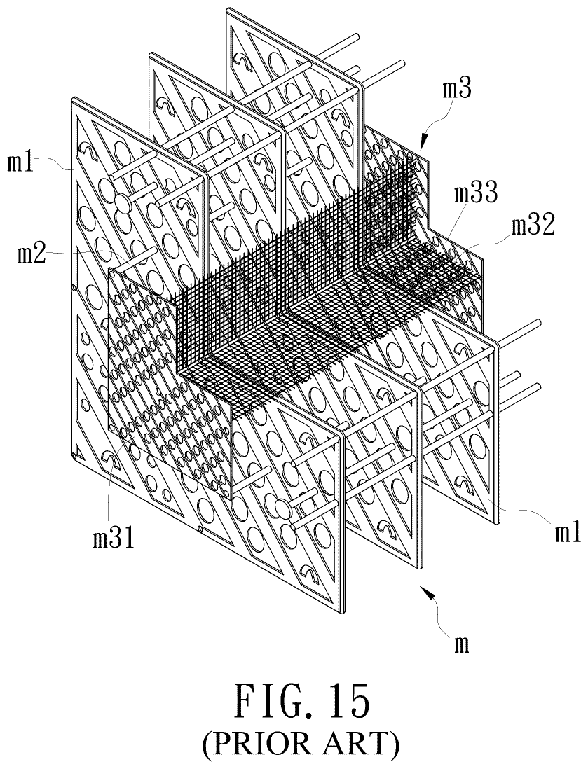

### DETAILED DESCRIPTION OF THE PREFERRED

### Embodiment

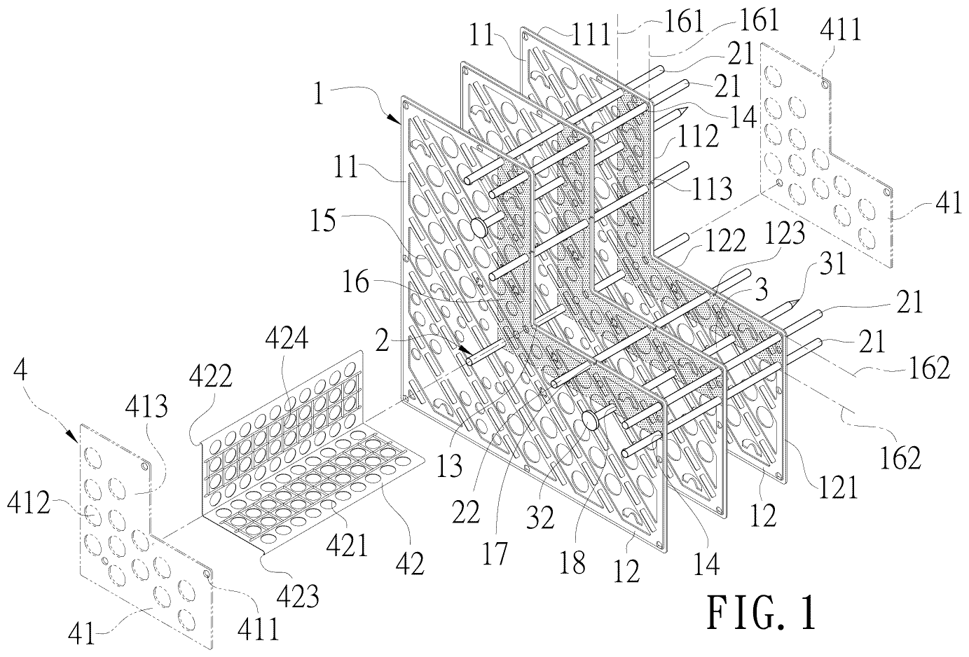

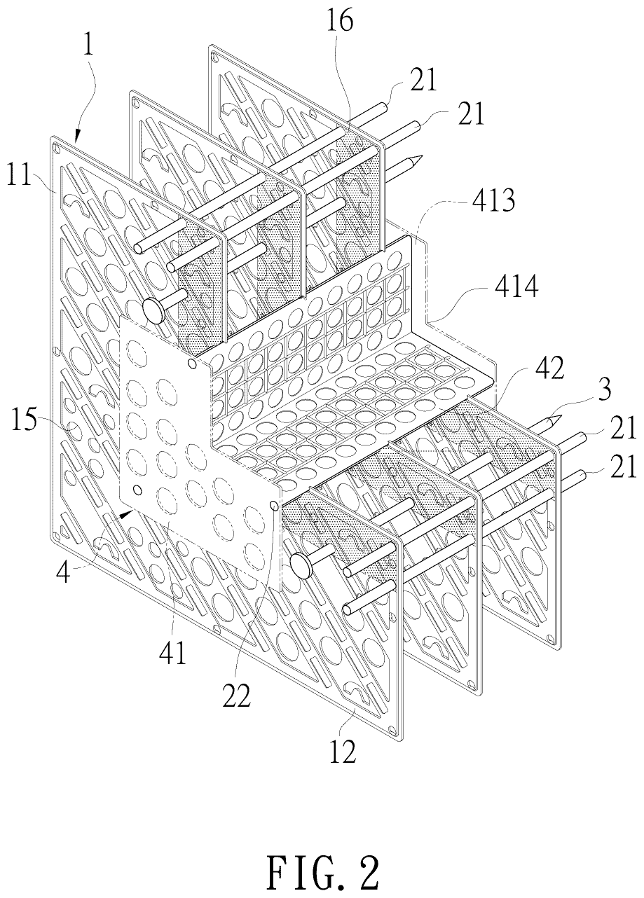

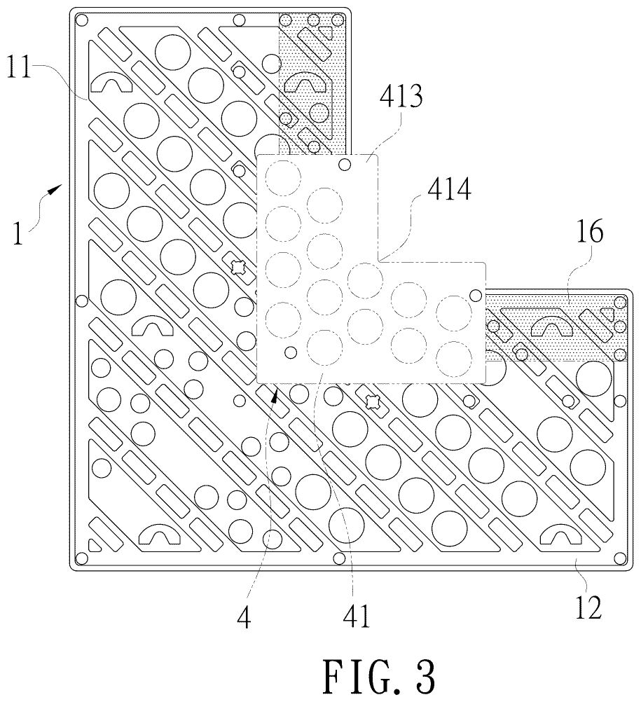

Refer to FIG. 1-3, an anti-crack assembly for corner walls of doors and windows according to the present invention is provided. The anti-crack assembly for walls at corners of doors and windows according to the present invention includes a plurality of anti-crack components 1, a plurality of fixing rods 2, at least one positioning rod 3, and a reinforcement unit 4.

The anti-crack components 1 are horizontally spaced apart from and corresponding to one another. Thus the first anti-crack component 1 located at the foremost and the last anti-crack component 1 located furthest are formed.

The anti-crack component 1 consists of a first piece portion 11 arranged vertically and a second piece portion 12 disposed horizontally. The first piece portion 11 and the second piece portion 12 are connected to form one part in a L-shape and a L-shaped first notch 13 is formed by one side of the first piece portion 11 and one side of the second piece portion 12. Two adjacent first fixing holes 14 are disposed beside the first notch 13 along both an end edge 111 of the first piece portion 11 in a lengthwise direction and an end edge 121 of the second piece portion 12 in a lengthwise direction. The anti-crack component 1 is further provided with a plurality of penetrating holes 15.

The fixing rods 2 include a plurality of first fixing rods 21 and a plurality of second fixing rods 22. The first fixing rods 21 are inserted through and fixed in the two first fixing holes 14 of the first piece portion 11 and the two corresponding first fixing holes 14 of the second piece portion 12 of the respective anti-crack components 1. The first piece portion 11 is provided with two imaginary vertical lines 161 which are defined as imaginary lines vertically passed through two of the first fixing rods 21. The second piece portion 12 is provided with two imaginary horizontal lines 162 which are defined as imaginary lines horizontally passed through two of the first fixing rods 21. An operation area 16 is formed and defined by the two imaginary vertical lines 161, the two imaginary horizontal lines 162, the end edge 111 of the first piece portion 11, and the end edge 121 of the second piece portion 12. A plurality of second fixing holes 17 and at least one positioning hole 18 are arranged at the operation area 16. Each of the second fixing rods 22 is inserted through and fixed in the corresponding second fixing holes 17 of the anti-crack components 1. Two ends of both the first fixing rod 21 and the second fixing rod 22 are projecting from an outer side of the first anti-crack component 1 and an outer side of the last anti-crack component 1 correspondingly.

The positioning rod 3 is inserted through the positioning holes 18 of the respective anti-crack components 1 correspondingly. In this embodiment, the positioning rod 3 is an iron nail provided with a sharp end 31 and a stopping end 32 located at two opposite ends of the positioning rod 3 correspondingly. A rod surface of the positioning rod 3 is abutting against a hole wall of the positioning hole 18.

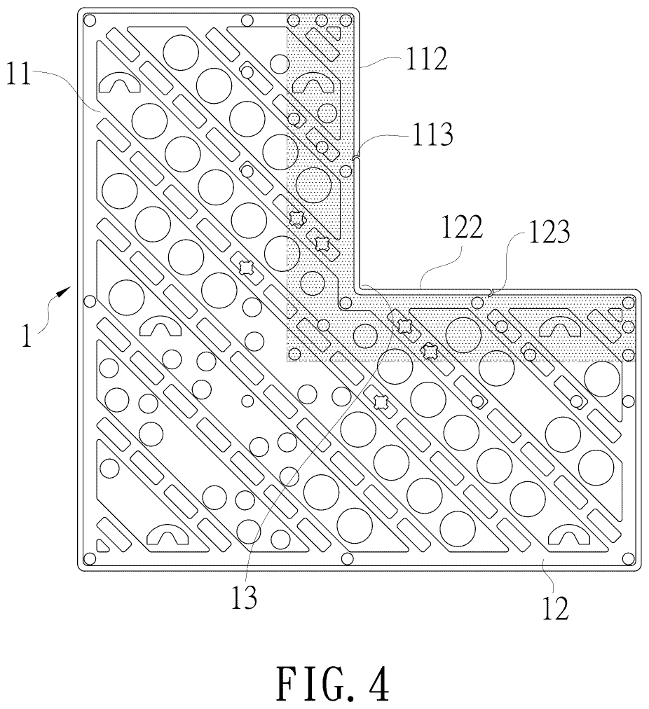

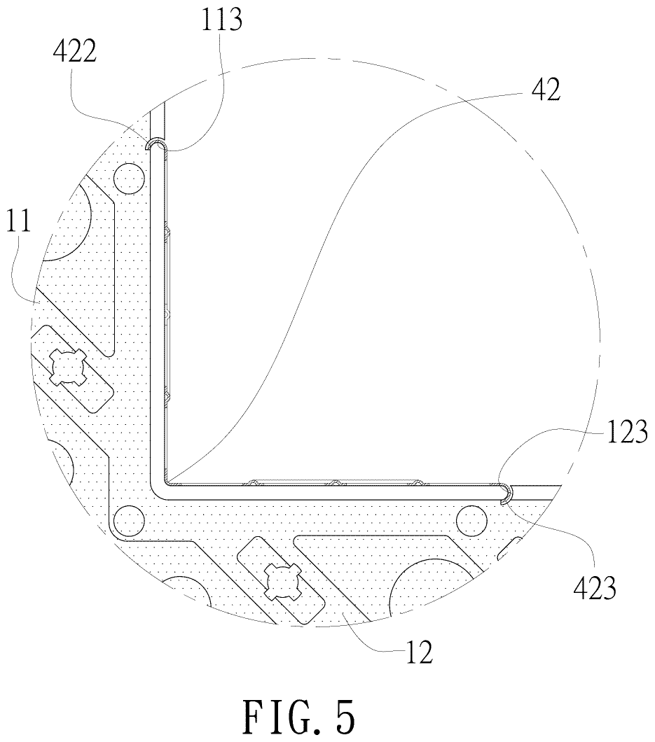

The reinforcement unit 4 is composed of two opposite reinforcement pieces 41 and an anti-shock piece 42 located between the two reinforcement pieces 41, both made of stainless steel. The two reinforcement pieces 41 are located at the two ends of the respective second fixing rods 22 and provided with a plurality of insertion holes 411. The insertion holes 411 are inserted and positioned by the two ends of the respective second fixing rods 22 correspondingly and then the reinforcement pieces 41 are joined and fixed to lateral sides of the anti-shock piece 42 by spot welding. Each of the reinforcement pieces 41 is provided with a seam reinforcing portion 413 projecting out of the first notch 13 of the anti-crack component 1 and located outside the area defined by the operation area 16. A right-angled recess 414 is formed on the seam reinforcing portion 413. The anti-shock piece 42 is going across the first notches 13 of the plurality of the anti-crack components 1 and bent into a L shape matched with a shape of the first notches 13 of the anti-crack components 1. The reinforcement pieces 41 and the anti-shock piece 42 are respectively provided with a plurality of first through holes 412 and a plurality of second through holes 421. Also refer to FIG. 4 and FIG. 5, the present assembly features on that: one side of the first piece portion 11 and one side of the second piece portion 12 which are combined to form the first notch 13 are respectively defined as a first side 112 and a second side 122. A first locking slot 113 and a second locking slot 123 are respectively mounted to the first side 112 of the first piece portion 11 and the second side 122 of the second piece portion 12. An edge of one side of the L-shaped anti-shock piece 42 of the reinforcement unit 4 adjacent to the first side 112 of the first piece portion 11 of the anti-crack component 1 is provided with a first locking hook portion 422 able to be engaged and connected with the first locking slot 113 of the first piece portion 11. An edge of one side of the L-shaped anti-shock piece 42 adjacent to the second side 122 of the second piece portion 12 of the anti-crack component 1 is provided with a second locking hook portion 423 able to be engaged and connected with the second locking slot 123 of the second piece portion 12. A rib 424 is disposed on a surface of the L-shaped ant-shock piece 42 and formed between at least two of the second through holes 421 adjacent to each other so that the surface of the L-shaped ant-shock piece 42 is uneven.

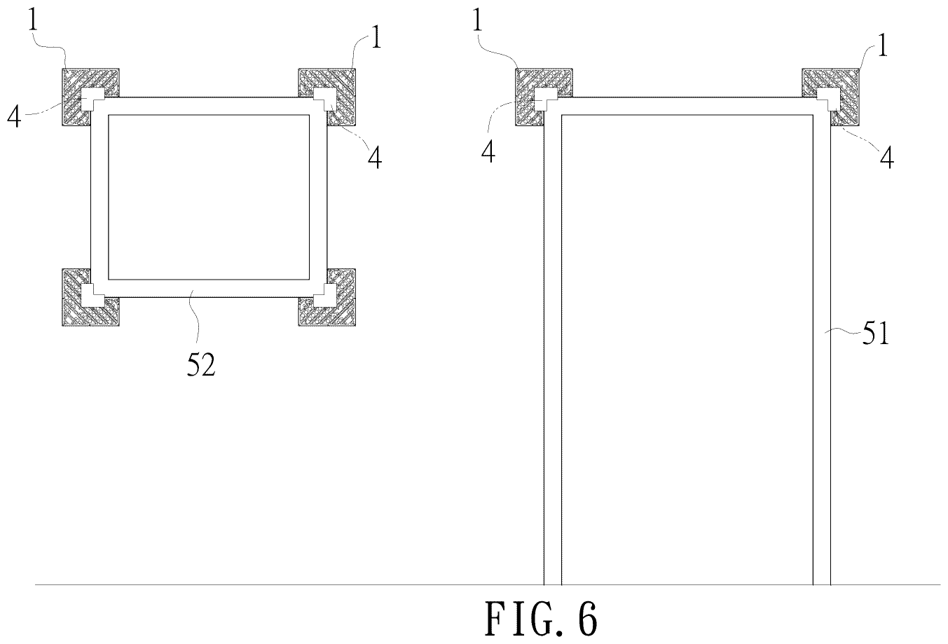

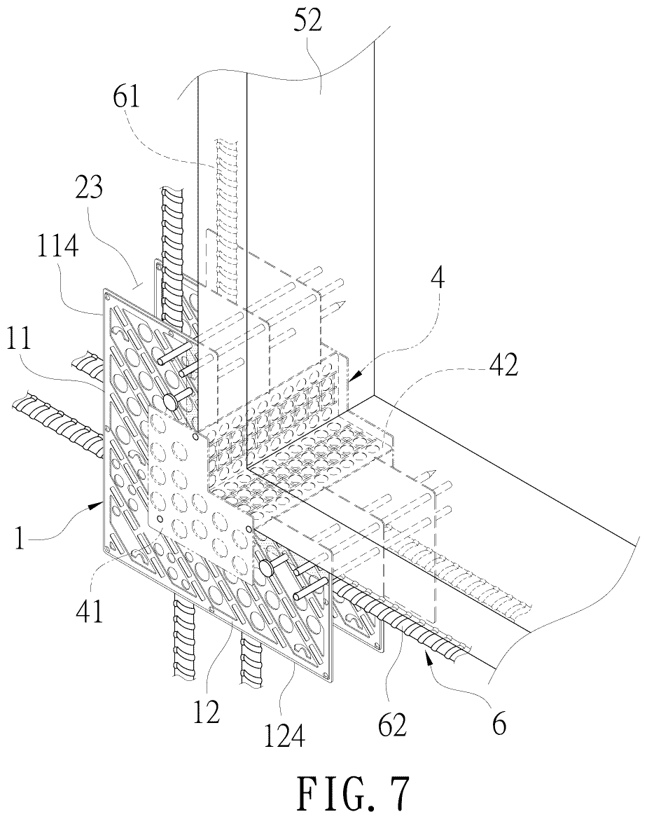

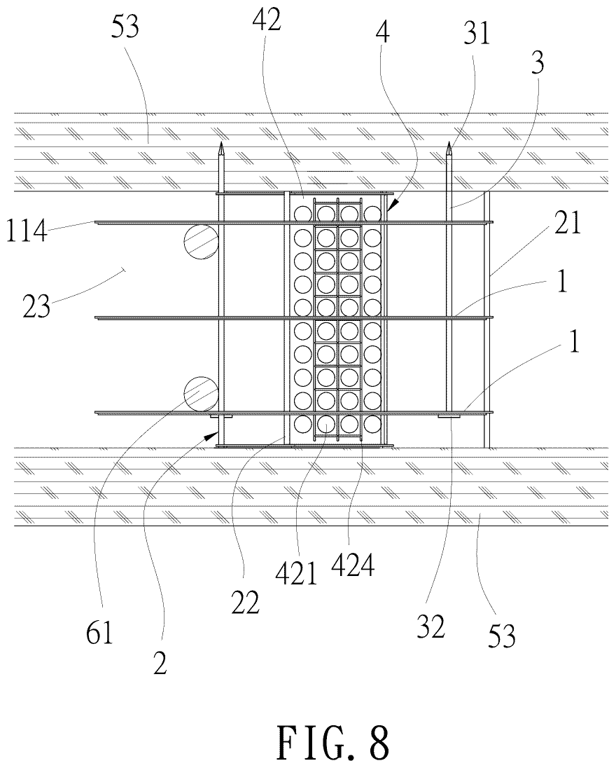

While in use, also refer to FIG. 6, the present assembly is mounted to each corner of a door frame template 51 or a window frame template 52. Each corner of the door frame template 51 and the window frame template 52 is abutting against the anti-shock piece 42 of the reinforcement unit 4. One end of both the first fixing rod 21 and the second fixing rod 22 is abutting against a template 53 and the sharp end 31 of the positioning rod 3 is inserted and stopped in the template 53. Then the stopping end 32 of the positioning rod 3 is driven by striking tools such as a hammer in construction personnel's hands so that the sharp end 31 of the positioning rod 3 is driven and fixed in the template 53. Refer to FIG. 7 and FIG. 8, after a plurality of the present anti-crack assemblies being driven into the template 53 and fixed at the corners of the door and the window frame templates 51, 52, a plurality of reinforcing bars 6 is arranged vertically and horizontally along a periphery of the door and the window frame templates 51, 52. While being applied, vertical steel rebars 61 and horizontal steel rebars 62 are respectively mounted in a reinforcing bar mounting area 23 through an outer side 114 of the first piece portion 11 and an outer side 124 of the second piece portion 12. The reinforcing bar mounting area 23 is formed among the outer side 114 of the first piece portion 11, the outer side 124 of the second piece portion 12, and the fixing rods 2 adjacent to the outer side 114 and the outer side 124. The vertical steel rebars 61 and the horizontal steel rebars 62 are respectively leaning against the fixing rod 2 adjacent to the outer side 114 of the first piece portion 11 and the fixing rod 2 adjacent to the outer side 124 of the second piece portion 12. Thereby convenience in arrangement of the reinforcing bars 6 is improved and an intersection between the vertical steel rebars 61 and the horizontal steel rebars 62 is tied and fixed by iron wires.

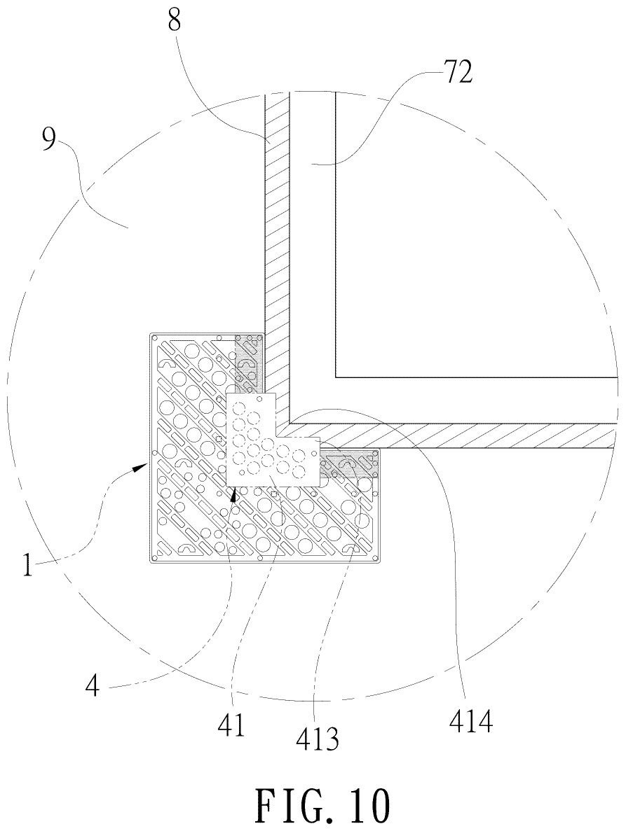

Next ready-mix concrete is filled into a space formed among the templates 53. At the moment, liquid concrete flows through intervals between the reinforcement pieces 41 of the reinforcement unit 4 of the anti-crack component 1 and the adjacent anti-crack components 1, the penetrating holes 15 of the anti-crack component 1, the first through holes 412 of the reinforcement pieces 41, and the second through holes 421 of the anti-shock piece 42. Thereby after solidification of the concrete to form a wall structure 9 (as shown in FIG. 10), the present assembly is firmly enclosed in the wall structure 9. By the plurality of holes disposed on the reinforcement pieces 41 and the anti-shock piece 42 of the reinforcement unit 4 and the ribs 424 arranged at the surface of the anti-shock piece 42, the surfaces of the reinforcement pieces 41 and the anti-shock piece 42 are bumpy. Thus bond area and connection stability between the present assemblies and the wall structure 9 are further increased. Therefore, anti-crack strength of the wall structure 9 at corners of the door and the window frame templates 51, 52 is further enhanced.

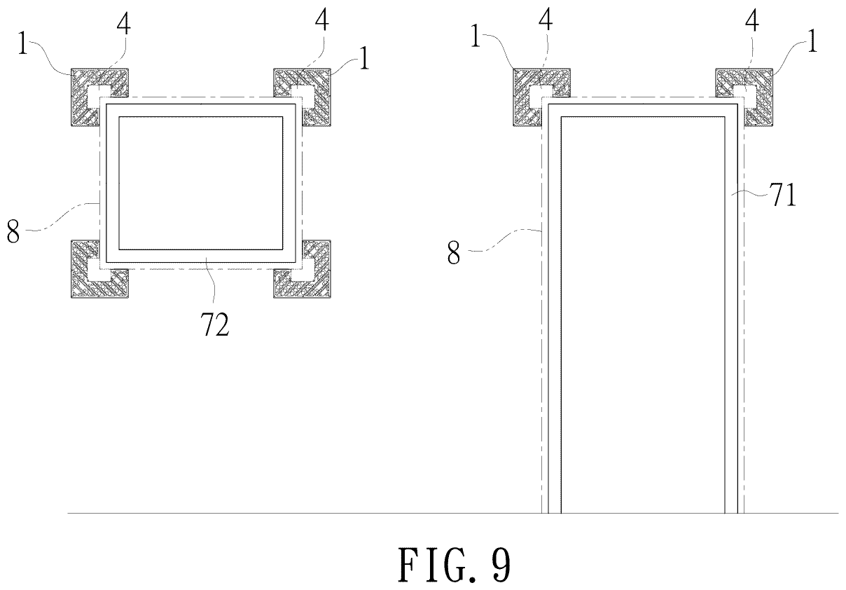

Moreover, after formation of the wall structure 9, the door and the window frame templates 51, 52 are removed. Also refer to FIG. 9 and FIG. 10, a normal door frame 71 and a normal window frame 72 are mounted to a door opening and a window opening of the wall structure 9. After being mounted, a gap is formed between the normal door frame 71 and the door opening of the wall structure 9, or between the normal window frame 72 and the window opening of the wall structure 9. The seam reinforcing portions 413 of the two reinforcement pieces 41 of the reinforcement unit 4 are just located at the gap and the recess 414 is corresponding to an angle of a corner of the normal door frame 71 or the normal window frame 72. Then cement mortar is used to fill the gap and a seam 8 is formed. Thus the seam reinforcing portions 413 of the reinforcement unit 4 are enclosed in the seam 8.

When the reinforced concrete (RC) walls have vibrations due to external forces such as earthquake or thermal expansion, stress is created at wall surfaces at the corners of the normal door frame 71 or the normal window frame 72. When the stress is transmitted to the anti-shock piece 42 located at the first notch 13 of the anti-crack component 1, the L-shaped anti-shock piece 42 is elastically deformed for buffering and absorbing the stress and changing transmission direction of the stress. Thus the stress transmitted to the wall structure 9 at the corners of the normal door frame 71 or the normal window frame 72 is reduced and dispersed. Thereby resistance to the stress and anti-crack performance of the wall structure 9 at the corners of the normal door frame 71 or the normal window frame 72 are improved. The wall structure 9 at the corners of the normal door frame 71 or the normal window frame 72 and its paint layer are further protected from cracks or micro-cracks. Moreover, as to the stress transmitted to the seam 8, the anti-crack strength of the seam 8 is improved and the stress acted on the seam 8 is absorbed due to reinforcement effect of the seam reinforcement portions 413 of the reinforcement unit 4 on the seam 8. Thus the seam 8 and its paint layer are protected from cracks or micro-cracks effectively.

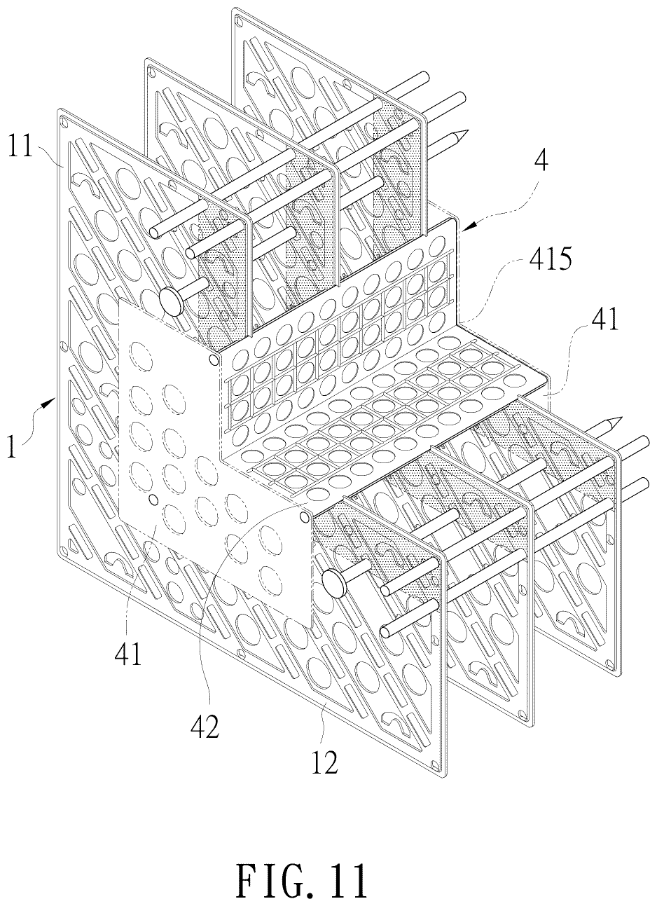

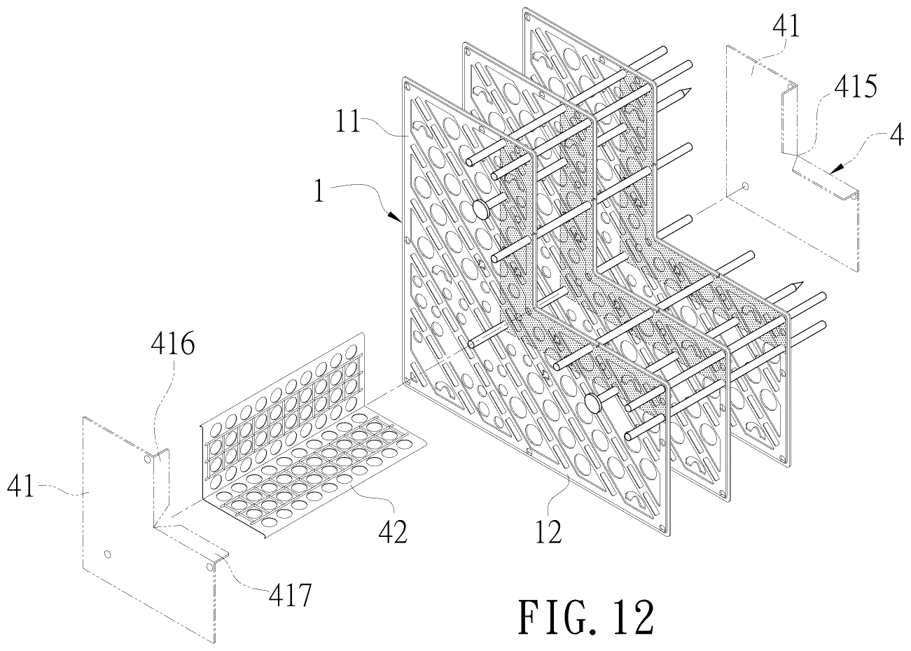

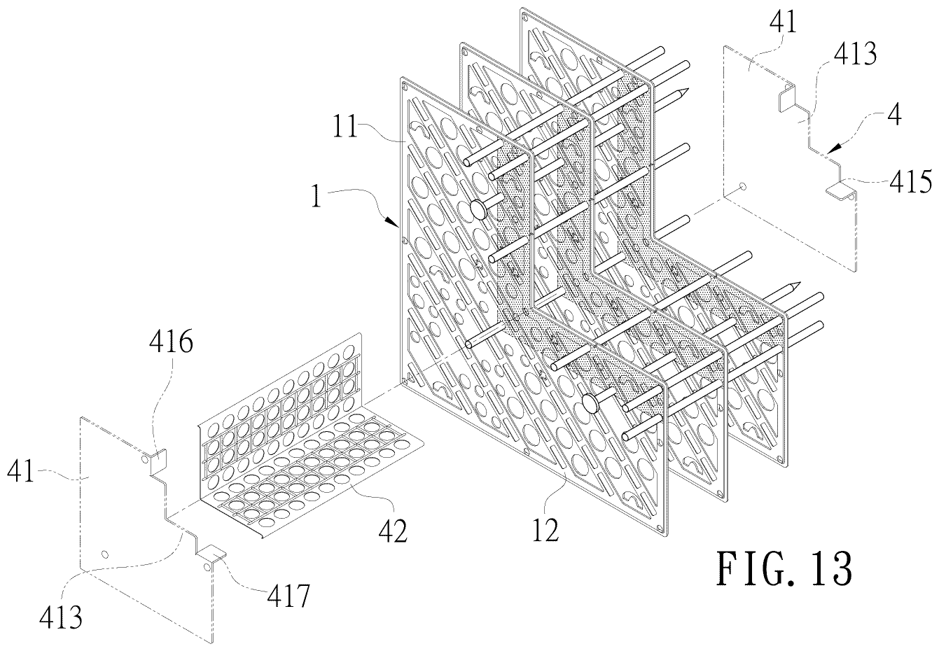

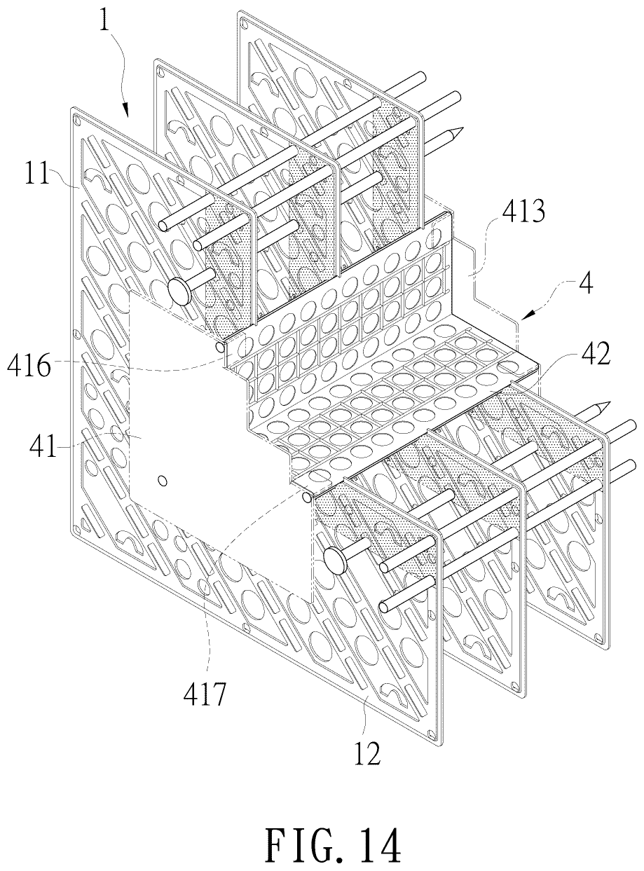

Refer to FIG. 11, another embodiment is provided. In this embodiment, the seam reinforcement portion 413 on each of the reinforcement pieces 41 of the reinforcement unit 4 is omitted and a second notch 415 is formed at the original position of the seam reinforcement portion 413. The second notch 415 of each of the reinforcement pieces 41 is in a shape matched with the L-shaped first notch 13 of the anti-crack component 1 and located at a position corresponding to the L-shaped first notch 13 of the anti-crack component 1. Also refer to FIG. 12, a further embodiment is provided. At least one of a piece of first connection portion 416 and a piece of second connection portion 417 is connected to at least one of a vertical side and a horizontal side of the L-shaped second notch 415 of each of the two reinforcement pieces 41 of the reinforcement unit 4. In this embodiment, the piece of first connection portion 416 and the piece of second connection portion 417 are respectively connected to a vertical side and a horizontal side of the second notch 415 of each of the reinforcement pieces 41 of the reinforcement unit 4. While being assembled, the first connection portion 416 and the second connection portion 417 of each of the reinforcement pieces 41 are bent toward the anti-shock piece 42 and arranged adjacent to the anti-shock piece 42 and then overlapped with the anti-shock piece 42. Then an area of the first and the second connection portions 416, 417 and an area of the anti-shock piece 42 overlapped with each other are connected by spot welding. Thereby the reinforcement pieces 41 and the anti-shock piece 42 are connected more firmly. Refer to FIG. 13 and FIG. 14, a further embodiment is provided. A seam reinforcement portion 413 is mounted to the second notch 415 of each of the reinforcement pieces 41 of the reinforcement unit 4. The seam reinforcement portion 413 is projecting out of the first notch 13 of the anti-crack component 1. At least one side of the second notch 415 of each of the two reinforcement pieces 41 is positioned adjacent to the seam reinforcement portion 413 and is connected to at least one of a piece of first connection portion 416 and a piece of second first connection portion 417. In this embodiment, the piece of first connection portion 416 and the piece of second connection portion 417 are respectively connected to a vertical side and a horizontal side of the second notch 415 of each of the reinforcement pieces 41 of the reinforcement unit 4 and both located beside the seam reinforcement portion 413. While being assembled, the first connection portion 416 and the second connection portion 417 of each of the reinforcement pieces 41 are bent toward the anti-shock piece 42, arranged adjacent to the anti-shock piece 42, and overlapped with the anti-shock piece 42. Then an area of the first and the second connection portions 416, 417 and an area of the anti-shock piece 42 overlapped with each other are connected by spot welding. Thereby contact area between the reinforcement pieces 41 and the anti-shock piece 42 is increased by disposition of the first and the second connection portions 416, 417. Therefore, the connection between the reinforcement pieces 41 and the anti-shock piece 42 by spot welding is more stable and convenient.

According to the above embodiments, it is learned that the present invention has the following advantages.

1. A locking slot is formed on each of the two sides of the first piece portion and the second piece portion which form the first notch. An edge on each of the two sides of the anti-shock piece of the reinforcement unit is provided with a locking hook portion able to be engaged and connected with the locking slot of the first piece portion and the second piece portion. Thereby the reinforcement unit and the anti-crack components are assembled more conveniently.

2. The improvement of the present anti-crack assembly is in that an anti-shock piece is going across the first notches of the anti-crack components. When the stress is transmitted to the anti-shock piece, the anti-shock piece is elastically deformed for buffering and absorbing the stress and changing transmission direction of the stress. Thereby resistance to the stress and anti-crack performance of the wall structure at the corners of the door and the window frames are improved. The wall structure at the corners of the door and the window frames and its paint layer are further protected from micro-cracks.

3. The reinforcement pieces of the reinforcement unit and the anti-shock piece are both provided with a plurality of through holes. The ribs are disposed on the surface of the ant-shock piece so that the surface of the ant-shock piece is bumpy and uneven. Thus bond area and connection stability between the present anti-crack assembly and the wall structure are further increased. The anti-crack strength of the wall structure at the corners of the door and the window frames is further improved.

4. At least one connection portion is connected to one side of the second notch on the reinforcement piece of the reinforcement unit. The connection portion is overlapped with the anti-shock piece so that contact area between the reinforcement pieces and the anti-shock piece is increased and this helps the connection between the reinforcement pieces and the anti-shock piece by spot welding. The reinforcement pieces and the anti-shock piece are connected more stably and conveniently.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An anti-crack assembly for corner walls of doors and windows comprising:
a plurality of anti-crack components arranged corresponding to one another and spaced apart from one another; the anti-crack component having a first piece portion arranged vertically and a second piece portion disposed horizontally; the first piece portion and the second piece portion connected to form one part and a first notch formed by one side of the first piece portion and one side of the second piece portion; two adjacent first fixing holes disposed beside the first notch and along both an end edge of the first piece portion and an end edge of the second piece portion;
a plurality of fixing rods having a plurality of first fixing rods and a plurality of second fixing rods; the first fixing rods inserted through and fixed in the two first fixing holes of the first piece portion and the two corresponding first fixing holes of the second piece portion of the respective anti-crack components; the first piece portion provided with two imaginary vertical lines which are defined as imaginary lines vertically passed through two of the first fixing rods; the second piece portion provided with two imaginary horizontal lines which are defined as imaginary lines horizontally passed through two of the first fixing rods; an operation area formed and defined by the two imaginary vertical lines, the two imaginary horizontal lines, the end edge of the first piece portion, and the end edge of the second piece portion; a plurality of second fixing holes and at least one positioning hole arranged at the operation area; the second fixing rods inserted through and fixed in the corresponding second fixing holes of the anti-crack components; two ends of both the first fixing rod and the second fixing rod projecting from an outer side of the first anti-crack component and an outer side of the last anti-crack component correspondingly;
at least one positioning rod inserted through the corresponding positioning holes of the anti-crack components;
a reinforcement unit having two reinforcement pieces and an anti-shock piece; the two reinforcement pieces disposed on the two ends of the second fixing rods correspondingly; the anti-shock piece located between the two reinforcement pieces, going across the first notches of the plurality of the anti-crack components, and in a shape matched with a shape of the first notches of the anti-crack components;
wherein the anti-crack assembly is characterized in that: one side of the first piece portion and one side of the second piece portion which are combined to form the first notch are respectively defined as a first side and a second side; the first side of the first piece portion and the second side of the second piece portion are respectively provided with a first locking slot and a second locking slot; an edge of one side of the anti-shock piece adjacent to the first side of the first piece portion of the anti-crack component is provided with a first locking hook portion able to be engaged and connected with the first locking slot of the first piece portion of the anti-crack component; an edge of one side of the anti-shock piece adjacent to the second side of the second piece portion of the anti-crack component is provided with a second locking hook portion able to be engaged and connected with the second locking slot of the second piece portion of the anti-crack component.

2. The anti-crack assembly as claimed in claim 1, wherein a seam reinforcing portion is formed on the reinforcement piece of the reinforcement unit and projecting out of the first notch of the anti-crack component.

3. The anti-crack assembly as claimed in claim 1, wherein the two reinforcement pieces of the reinforcement unit are provided with a plurality of insertion holes which are inserted by the two ends of the second fixing rods correspondingly.

4. The anti-crack assembly as claimed in claim 1, wherein the reinforcement piece of the reinforcement unit is provided with a plurality of first through holes.

5. The anti-crack assembly as claimed in claim 1, wherein the anti-shock piece of the reinforcement unit is provided with a plurality of second through holes.

6. The anti-crack assembly as claimed in claim 1, wherein a plurality ribs is arranged at the anti-shock piece of the reinforcement unit.

7. The anti-crack assembly as claimed in claim 1, wherein the anti-crack component is provided with a plurality of penetrating holes.

8. The anti-crack assembly as claimed in claim 1, wherein the reinforcement piece of the reinforcement unit is provided with a second notch; the second notch of the reinforcement piece is in a shape matched with a shape of the first notch of the anti-crack components and located at a position corresponding to the first notch of the anti-crack component.

9. The anti-crack assembly as claimed in claim 8, wherein at least one of a piece of first connection portion and a piece of second connection portion is connected to at least one side of the second notch of the reinforcement piece of the reinforcement unit; the first connection portion and the second connection portion are arranged adjacent to and overlapped with the anti-shock piece and connected with the anti-shock piece.

10. The anti-crack assembly as claimed in claim 8, wherein a seam reinforcement portion is formed at the second notch of the reinforcement piece of the reinforcement unit; the seam reinforcement portion is projecting out of the first notch of the anti-crack component; at least one of a piece of first connection portion and a piece of second connection portion is connected to at least one side of the second notch of the reinforcement pieces and located beside the seam reinforcement portion; the first connection portion and the second connection portion are arranged adjacent to and overlapped with the anti-shock piece and connected to the anti-shock piece.
